(19) United States
(12) Patent Application Publication
(10) Pub. No.: US 2023/0374260 A1
(43) Pub. Date: Nov. 23, 2023

(54) Dual Layer Antimicrobial Product

(71) Applicants: TE Connectivity Solutions GmbH, Schaffhausen (CH); Tyco Electronics UK Ltd., Swindon (GB)

(72) Inventors: Kaylie Jane SMITH, Oxford (GB); Lei WANG, San Jose, CA (US); Yiliang WU, San Ramon, CA (US); Ting GAO, Palo Alto, CA (US); Chun Kwan Tsang, Newark, CA (US)

(73) Assignees: TE Connectivity Solutions GmbH, Schaffhausen (CH); Tyco Electronics UK Ltd, Swindon (GB)

(21) Appl. No.: 17/750,710

(22) Filed: May 23, 2022

(51) Int. Cl. C08K 5/00; B32B 27/32; C08J 3/22; B32B 27/08; B32B 27/30; B32B 27/34; C08K 3/016; C08K 3/32; B29C 48/08

(52) U.S. Cl. CPC C08K 5/0058; B32B 27/32; C08J 3/226; B32B 27/08; B32B 27/308; B32B 27/34; C08K 3/016; C08K 3/32; B29C 48/08

(57) ABSTRACT

An antimicrobial product comprising an inner layer and an outer layer surrounding said inner layer wherein said inner layer is crosslinked. The outer layer includes at least one antimicrobial additive. A process of forming such antimicrobial product using extrusion is described.

### FIELD OF THE INVENTION

The present invention is directed to a dual layer antimicrobial product in which the product has an inner layer and an outer layer. The outer layer surrounds the inner layer. The outer layer includes an antimicrobial additive to give the product antimicrobial properties to the product. The outer layer may be crosslinked as well as the inner layer.

### BACKGROUND OF THE INVENTION

Antimicrobials are chemical compounds that reduce and/or mitigate the growth or development of microbial organisms. Antimicrobial additives work by a variety of mechanisms dependent upon the mode of action, composition, degree of activity, and application. When used properly, antimicrobial compounds lead to the death or arrested growth of the targeted microorganisms. Since their discovery in the early 1900s, antimicrobials have transformed the prevention and treatment of infectious diseases. Antimicrobial additives are currently used across a very wide array of applications, including the use of antimicrobials in the polymeric materials used in various consumer products, packaging materials, medical applications and any other application or article in which human contact is experienced. For example, polymeric materials that include antimicrobial additives can be used to make articles and devices that will then eliminate, reduce and/or mitigate the growth or development of microbial organisms.

However, antimicrobials may also be hazardous to human health. Therefore, there is a need for antimicrobial additives that do not leach out of the materials in which they are used. Further there is a need for antimicrobial additives which do not leach out of the materials in which they are used and which remain effective over the life of usage of the material, or the article or device made from the material in which the antimicrobial additive is used.

Ideally, the antimicrobial agents that provide these non-leaching antimicrobial properties would have a proven history of use and effective activity against various microorganisms without any adverse effect on person using the product. The antimicrobial material, or other materials containing the antimicrobial additive, should be applicable to products and/or surfaces thereof by commercially-viable manufacturing methods such as molding, extrusion, and all other methods of processing polymeric materials. In addition, the antimicrobial additive should not interfere with the physiochemical, electrical, and/or mechanical properties of the treated material, product and/or surface there.

One approach to reduce microbial contamination is to develop surfaces with bactericidal activity, for example by making or coating the surface with a material that will release antimicrobial compounds. Almost all treatments fall into one of the following three categories: 1) adsorption of the antimicrobial additive into the surface of materials passively or in combination with surfactants or by way of surface-bonded polymers; 2) incorporation of the antimicrobial additive into a polymer coating applied on the material surface; 3) compounding the antimicrobial additive into the bulk material comprising the device.

However, all of these approaches the antimicrobial additive can leach or migrate out of the material in which it has been added. This means the antimicrobial performance of the material is generally dependent on the concentration of the antimicrobial additive (loading) and the rate of its release from the material to which it has been added. It is often very difficult to control the release rate and maintain a constant level of concentration at the surface as the release rate depends on many factors such as actual concentration, solubility, and diffusivity of these active ingredients in the bulk polymer which may also change over the time of use. All of these issues mean approaches based on this leaching mechanism are often ineffective.

Japanese Patent Publication No. 2002103572A describes a three layered polystyrene heat-shrinkable film with antibacterial properties. An antibacterial agent such as silver is used in one of the two outer layers to impart antibacterial properties to the three layered film. The antibacterial agent is used in an amount of 0.05 to 1.0 party by weight based upon 100 parts by weight of the polystyrene resin composition making up the two outer layers. The Publication also describes a method for producing the three layered film.

Japanese Publication No. JPH09248875A describes a two or three layer film structure. The bottom layer is a heat shrinkable film formed of a polyvinyl chloride film or a polyethylene terephthalate film. The upper layer is a transparent ink layer which includes the antimicrobial agent comprising silver, copper or zinc.

U.S. Patent Publication No. 2006/0088678A1 describes a dual ovenable film having a first layer comprising one or more polyamides and a second layer including one or more polyamides. The one or more layers may include one or more additives useful in packaging films, such as, antiblocking agents, slip agents, antifog agents, colorants, pigments, dyes, flavorants, antimicrobial agents, meat preservatives, antioxidants, fillers, radiation stabilizers, and antistatic agents. Such additives, and their effective amounts, are known in the art.

U.S. Patent Publication No. 2011/0081530 describes a method of manufacturing of an antimicrobial polymeric film. The method comprises coextruding a polymeric substrate layer comprising a first layer of a first polymeric material and a second layer of a second polymeric material wherein the crystalline melt temperature of the second polymeric material is lower than the crystalline melting temperature of the first polymeric material. The coextruded substrate is stretched in a first direction. A polymeric second layer comprising a particulate antimicrobial and liquid vehicles are disposed on the substrate. The stretched film is then heat set. By applying the particulate antimicrobial compound to the coextruded film, it was found that greater antimicrobial activity was obtained.

In the article “Dual layer hollow fiber PVDF ultra-filtration membranes containing AG nano-particle loaded zeolite with longer term anti-bacterial capacity in salt water”, published in Water, Science & Technology (Vol. 73.9, 2016, p 2159-2167) the authors describe a dual layer polyvinylidene fluoride (PVDF) membrane with antibacterial particles. The antibacterial particles are silver nano-particles loaded zeolite which was in the outer layer. The authors note that this dual layer hollow fiber membrane can be used in sea water pretreatment devices with long term antifouling capability for the desalination process.

U.S. Pat. No. 9,918,466 B2 describes an antimicrobial polymer. The polymer can be produced by the incorporation of an antimicrobial ingredient into the polymer by grafting, copolymerization, or via a combined antimicrobial/plasticizer ingredient. The polymer may be produced as a masterbatch, or a ready to process polymer for producing antimicrobial products. The reactions may be conducted in a reactive extruder to provide a single-step synthesis. Some examples of antimicrobial ingredients that may be bonded include, but are not limited to quaternary ammonium salts, quaternary phosphonium salts, chlorhexidine derivatives, polyhexamethylene biguanide derivatives, povidone iodine, starch-iodine derivatives, and combinations thereof.

U.S. Pat. No. 10,051,867 B2 describes antimicrobial polymer concentrates and compounds. The patent describes antimicrobial masterbatches using migratory assisting agents to improve antimicrobial efficiency. Migratory assisting agents function by carrying the antimicrobial agent while the migratory assisting agent transfers or migrates to the surface of the polymer compound or article. As a result, antimicrobial agents are brought to the surface where there is exposure to bacterial contamination. Antimicrobial agents which can be used are chlorhexidine, chlorhexidine gluconate, glutaral, halazone, hexachlorophene, nitrofurazone, nitromersol, povidone-iodine, thimerosol, parabens, hypochlorite salts, clofucarban, clorophene, poloxamer-iodine, phenolics, mafenide acetate, aminacrine hydrochloride, quaternary ammonium salts, oxychlorosene, metabromsalan, merbromin, dibromsalan, glyceryl laurate, sodium and/or zinc pyrithione, (dodecyl) (diethylenediamine) glycine and/or (dodecyl) (aminopropyl) glycine; phenolic compounds, polymeric guanidines, quaternary ammonium salts, polymyxins, bacitracin, circulin, the octapeptins, lysozmye, lysostaphin, cellulytic enzymes generally, vancomycin, ristocetin, actinoidins, avoparcins, tyrocidin A, gramicidin S, polyoxin D, tunicamycin, neomycin, and streptomycin. Migratory assisting agents are any agents that blooms to the surface.

U.S. Pat. No. 11,267,930 B2 describes a process of making an antimicrobial polymer composition. The process comprises mixing an antimicrobial additive into a polymeric material. The polymeric material comprises a polymeric backbone made up of a urethane linkage derived from a polyisocyanate and a polyol. The mixing occurs under conditions that result in the breaking of a minority of the urethane bonds resulting in reactive isocyanate groups. The reactive isocyanate groups react with the antimicrobial additive to covalently bond the additive into the polymer backbone resulting in an antimicrobial polymer composition.

It would, therefore, be beneficial to provide a dual layer antimicrobial product which eliminates the problems described above. In particular, it would be beneficial to provide dual layer antimicrobial product comprising an inner layer and an outer layer surrounding the inner layer in which the outer layer contains an antimicrobial additive.

### SUMMARY OF THE INVENTION

An embodiment is directed an antimicrobial product comprising an inner layer, and an outer layer surrounding the inner layer, wherein said outer layer includes at least one antimicrobial additive.

An embodiment is directed to the process of making an antimicrobial product comprising extruding an inner layer and an outer layer on top of said inner layer, wherein said outer layer includes at least one antimicrobial additive.

Other features and advantages of the present invention will be apparent from the following more detailed description of the illustrative embodiment, which illustrates, by way of example, the principles of the invention.

### DETAILED DESCRIPTION OF THE INVENTION

In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The invention is directed to dual layer antimicrobial product comprising an inner layer and an outer layer placed on top of such inner layer. The outer layer preferably includes at least one antimicrobial additive.

As used herein, the terms “polymer” or “polymeric” refer to a material that is a homopolymer, copolymer or terpolymer of the like.

As used herein, the term “antimicrobial” means any material that kills microorganisms or inhibits their growth. Preferably antimicrobial means a greater than 3 log reduction, preferably a greater than 4 log reduction, and more preferably a greater than 5 log reduction in a population of microbes relative to a control, according to ISO22196 test standard which is a recognized method to quantify the antimicrobial activity level of an antimicrobial surface (samples are exposed to bacteria for a 24 hour period at 37 degrees C.). In a preferred embodiment, the term antimicrobial means a greater than 3 log reduction, preferably a greater than 4 log reduction, and more preferably a greater than 5 log reduction in a population of microbes relative to a control, measured after 12 hours, preferably after 6 hours, more preferably after 3 hours.

As used herein, the term “antifouling” refers to a material that prevents or retards the formation of a biofilm on a surface. The antifouling material may work by preventing or reducing the adhesion of microorganisms to the surface.

The outer layer is preferably a polymer. Non-limiting examples of large polymers include polyolefins, polyamides, polyesters, poly (meth)acrylates, polycarbonates, polyvinyl alcohols, polynitriles, polyacetals, polyimides, polyarylketones, polyetherketones, polyhydroxyalkanoates, polycaprolactones, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them. In some specific embodiments, the outer layer is made from an amorphous polymer. In other specific embodiments, the outer layer is prepared from a semi-crystalline polymer.

Many commercial species of these categories of polymers exist that can be used as the outer layer of the antimicrobial product. Non-limiting examples of specific commercial polymers include acrylonitrile butadiene styrene (ABS), polymethyl methacrylate (PMMA), cellulose acetate, cyclic olefin copolymer (COC), ethylene-vinyl acetate (EVA), ethylene vinyl alcohol (EVOH), polytetrafluoroethane (PTFE), ionomers, polyoxymethylene (POM or Acetal), polyacrylonitrile (PAN), polyamide 6, polyamide 6,6, polyamide-imide (PAI), polyaryletherketone (PAEK), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxybutyrate (PHB), polyethylene (PE), polyetheretherketone (PEEK), polyetherketoneketone (PEKK), polyetherimide (PEI), polyethersulfone (PES), chlorinated polyethylene (CPE), polyimide (PI), polylactic acid (PLA), polymethylpentene (PMP), polyphenylene oxide (PPO), polyphenylene sulfide (PPS), polyphthalamide (PPA), polypropylene (PP), polysulfone (PSU), polytrimethylene terephthalate (PTT), polyurethane (PU), polyvinyl acetate (PVA), ethylene methyl acrylate polymer (EMA) and styrene-acrylonitrile (SAN).

The outer layer includes at least one antimicrobial additive. Antimicrobial additives can be either inorganic antimicrobial additives or organic antimicrobial additives.

Inorganic antimicrobial additives are inorganic compounds which contain a metal or metal ions, such as silver, zinc, gold, platinum, palladium, tin, nickel, iron, copper and the like which have antimicrobial properties. The metal-containing species may be supported on an inorganic substance such as silica or like metal oxides, zeolite, synthetic zeolite, metal loaded zeolites, metal doped phosphate based glasses, zirconium phosphate, calcium phosphate, calcium zinc phosphate, ceramics, soluble glass powders, alumina silicone, titanium zeolite, apatite, calcium carbonate and the like. Other metal-containing antimicrobial compounds include mercury acetates and organozinc compounds. If an inorganic antimicrobial additive is used in the outer layer, it comprises about from 0.1% to about 8% or from about 0.5% to about 5% by of the composition of the outer layer.

Organic antimicrobials are organic or organometalic compounds such as quaternary ammonium salts, phenols, alcohols, aldehydes, iodophores, poly quats (such as oligomeric poly quats derivatized from an ethylenically unsaturated diamine and an ethylenically unsaturated dihalo compound), biguanides, benzoates, parabens, sorbates, propionates, imidazolidinyl urea, 1-(3-chloroallyl)-3,5,7-triaza-1-azoniaadamantane chloride (Dowacil 200, Quaternium), isothiazolones, DMDM hydantoin (2,3-imidazolidinedione), phenoxyethanol, bronopol, fluoroquinolones (such as ciprofloxacin), “potent” beta-lactams (third and fourth generation cephalosporins, carbapenems), beta-lactam/beta-lactamase inhibitors, glycopeptides, aminoglycosides, antibiotic drugs, heparin, phosphorylcholine compounds, sulfobetaine, carboxybetaine, and organometallic compounds/complexes containing silver, zinc, and copper and their derivatives. Additional examples of these organic antimicrobial agents includes 3-iodo-2-propynyl-n-butylcarbamate, n-butyl-1,2-benzisothiazolin-3-one, and pharmaceutical drugs such as penicillin, trichlosan, functional biguanides, mono-functional polyquaterniums, quaternized mono-functional polyvinylpyrrolidones (PVP), silane quaternary ammonium compounds, and other quaternized ammonium salts. If an organic antimicrobial additive is used in the outer layer, it comprises about from about 0.1% to about 10%, including from about 0.1% to about 8% or from about 0.5% to about 5% by weight of the composition of the outer layer.

The outer layer may include additional additives conventionally employed in the manufacture of products made from polymers. Suitable additives include pigments, dyes, voiding agents, antistatic agents, foaming agents, plasticizers, binders, radical scavengers, anti-blocking agents, anti-dust agents, antifouling agents, surface active agents, slip aids, optical brighteners, plasticizers, viscosity modifiers, gloss improvers, dispersion stabilizers, UV stabilizers, UV absorbers, antioxidants, lubricity agents, heat stabilizers, hydrolysis stabilizers, cross-linking activators, layered silicates, radio opacifiers, such as barium sulfate, tungsten metal, non-oxide bismuth salts, fillers, colorants, reinforcing agents, adhesion mediators, impact strength modifiers, antimicrobials, and any combination thereof. Such additives may be included in conventional amounts. Preferably, these additional additives are generally in the range of about 0.5% to about 50%, including from about 0.5% to about 40% or from about 1% to about 30% by weight of the composition of the outer layer. These can be mixed into the composition of the outer layer in any conventional manner desired.

Optionally, a flame retardant can be used in either layer. The flame retardant can be a non-halogenated phosphorus flame; a halogenated flame retardant or an inorganic metal based flame retardant. Examples of non-halogenated phosphorus flame retardants include metal phosphinate salts, a metal diphosphinate salt, melamine cyanurate, melamine phosphate compounds, piperazine pyrophosphate, ammonium polyphosphates, red phosphorus, phosphate esters or combinations thereof. Inorganic metal based flame retardants include magnesium hydroxide, aluminum trihydroxide and zinc borate. Examples of halogenated flame retardants include polybrominated diphenyl ethers, deabromodiphenyl ethers or decabromodiphenyl ethane. If used in the composition, the flame retardant, the flame retardant makes up from about 5% to about 50% by weight of the entire composition, including from about 5% to about 40%, or from about 10% to about 35% by weight of the entire composition.

The outer layer is preferably 5 microns to about 250 microns thick. More preferably, it is from 25 microns to 250 microns thick, most preferably 50 microns to 125 microns thick.

The inner layer can be made from the same polymeric material as the outer layer or a different material. The inner layer needs to adhere well to the outer layer and have a similar expansion/shrinking ratio as the outer layer. The inner layer is preferably made of polymers such as polyolefins, polyamides, polyesters, poly (meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them. The inner layer can be made from a semi-crystalline polymer. A semi-crystalline polymer is a polymer containing both a crystalline phase and an amorphous phase. In some embodiments, the polymer has up to 80% crystallinity, in other embodiment, the polymer has up to 50% crystallinity, or up to 30% crystallinity as measured by method such as X-ray diffraction.

Optionally, an adhesive layer can be used between the inner layer and the outer layer to ensure better adhesion between the two layers. Examples of suitable adhesives to be used include but are not limited to extrudable hot melt adhesives, polyolefin hot melt adhesives, polyamide hot melt adhesives, and polyurethane hot melt adhesives. The adhesive can be applied during the extrusion process as described below. The adhesive can be applied using any conventional method to apply adhesives, including but not limited to spray coating, and printing before the outer is extruded onto the inner layer.

The inner layer can optionally also include an antimicrobial additive. Similarly, the inner layer can include additional conventional additives used in the processing of polymers. The amount of the additional conventional additive in the inner layer can be the same amount as used in the outer layer The amount of the antimicrobial additive added to the inner layer is dependent upon the desired antimicrobial activity of the end product. The amount of the antimicrobial additive in the inner layer can be the same amount as used in the outer layer. Similarly, the additional of conventional additives is well within the scope of one of ordinary skill in the art. The amount of the conventional additives in the inner layer can be the same as the amount of conventional additives in the outer layer. The inner layer has a thickness of from about 100 microns to about 20,000 microns, including from about 300 microns to about 15,000 microns, or from about 500 microns to about 10,000 microns.

The product having the inner layer and outer layer surrounding the inner layer is formed using an extrusion process. One of ordinary skill in the art would be able to determine the conditions for the extrusion process depending upon the materials chosen for the inner layer and the outer layer which is placed on top of the inner layer, as well as the optional adhesive layer.

In one embodiment, the raw materials for the inner layer, including the polymer, and optional ingredients are compounded using a twin screw extruder and then pelletized, using known conventional methods. Similarly, the ingredients for the outer layer, including the polymer, the antimicrobial additive and other desired additives are compounded using a twin screw extruder and then pelletized using known conventional methods.

The pellets for the inner layer and the pellets for the outer layer are co-extruded using a single screw extruder. Conventional conditions are used for this co-extrusion process are used to form the desired shaped product and are well within the skill of one of ordinary skill in the art.

Once the product is co-extruded, the product is subject to cross-linking. The product of the invention can be optionally crosslinked using a crosslinker. A crosslinker is an agent or substance that enables crosslinking of the polymeric material of the product. The product of the invention can be optionally crosslinked through exposure to an agent such as heat, UV light, electron beam, or gamma-radiation with or without other crosslinking agents or substances. If radiation is used, the product is exposed to radiation in the range of 50 KGy to 1100 KGy, preferably 50 KGy to 300 KGy to obtain the desired cross-linking. Crosslinking agents are chemicals, monomers or polymers having more than one homo- or hetero-functional group, capable of linking two or more binder polymer strands, two or more particles and capable of linking polymer strands and particles to each other and to the surface. In some embodiments of the present invention, the crosslinker has more than one radical generating moiety, such as aryl ketone, azide, peroxide, diazo, carbene or nitrene generator. In other embodiments, the crosslinker has more than one reactive group such as vinyl, carboxy, ester, epoxy, hydroxyl, amido, amino, thio, N-hydroxy succinimide, isocyanate, anhydride, azide, aldehyde, cyanuryl chloride or phosphine that can thermochemically react with functionalized binder polymer. In addition, the product of the instant invention can be crosslinked using radical generators. Radicals generators can form new bonds through radical-radical combination, addition to unsaturated bonds, hydrogen abstraction and subsequent recombination, as well as possible electron transfer reactions. Examples of radical initiators include benzophenone, acetophenone derivatives, peroxyides, peroxy compounds, benzoin derivatives, benzilketals, hydroxyalkylphenones and aminoalkylphenones, O-acyl oximoketones, acylphosphin oxides and acylphosphonates, thiobenzoic S-esters, azo and azide compounds, triazines, 1,2 diketones, quinones, coumarins, xanthones, 3-iodo-2-propynyl-n-butylcarbamate and n-butyl-1,2-benzisothiazolin-3-one.

The inner layer of the final product can also be crosslinked using the methods described above.

The crosslinked material having antimicrobial properties can be formed into any desired shape, such as a sheets, pipes, profiles using standard manufacturing techniques for these products.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An antimicrobial product comprising: an inner layer and an outer layer surrounding said inner layer, wherein said inner layer is crosslinked, wherein said outer layer includes an antimicrobial additive.

2. The antimicrobial product of claim 1, wherein said outer layer is crosslinked.

3. The antimicrobial product of claim 1, wherein said inner layer comprises a polymer chosen from the group consisting essentially of: include polyolefins, polyamides, polyesters, poly (meth)acrylates, polycarbonates, polyvinyl alcohols, polynitriles, polyacetals, polyimides, polyarylketones, polyetherketones, polyhydroxyalkanoates, polycaprolactones, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

4. The antimicrobial product of claim 1, wherein said outer layer comprises a polymer chosen from the group consisting essentially of: include polyolefins, polyamides, polyesters, poly (meth)acrylates, polycarbonates, polyvinyl alcohols, polynitriles, polyacetals, polyimides, polyarylketones, polyetherketones, polyhydroxyalkanoates, polycaprolactones, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

5. The antimicrobial product of claim 3 wherein said inner layer and said outer layer comprises the same polymer.

6. The antimicrobial product of claim 1, wherein the antimicrobial product has a 3 log reduction of bacteria as measured using ISO 22196 test standard.

7. The antimicrobial product of claim 1, wherein said antimicrobial additive is an inorganic antimicrobial additive chosen from the group consisting essentially of: silver, zinc, gold, platinum, tin, nickel, iron, or copper or compounds containing silver, zinc, gold, platinum, tin, nickel, iron or copper, metal doped phosphate glasses and metal loaded zeolites.

8. The antimicrobial product of claim 1, wherein said antimicrobial additive is an organic antimicrobial additive chosen from the group consisting essentially of: quaternary ammonium salts, phenols, alcohols, aldehydes, iodophores, poly quats, biguanides, benzoates, parabens, sorbates, propionates, imidazolidinyl urea, 1-(3-chloroallyl)-3,5,7-triaza-1-azoniaadamantane chloride (Dowacil 200, Quaternium), isothiazolones, DMDM hydantoin (2,3-imidazolidinedione), phenoxyethanol, bronopol, fluoroquinolones, beta-lactams, beta-lactam/beta-lactamase inhibitors, glycopeptides, aminoglycosides, antibiotic drugs, heparin, phosphorylcholine compounds, sulfobetaine, carboxybetaine, and organometallic compounds containing silver, zinc, gold, platinum, palladium, tin, nickel, iron and copper element.

9. The antimicrobial product of claim 1, wherein the outer layer has a thickness of from about 25 microns to about 250 microns.

10. The antimicrobial product of claim 1, wherein said inner layer and said outer layer include a flame retardant.

11. The antimicrobial product of claim 1, wherein said inner layer includes a flame retardant.

12. The antimicrobial product of claim 1, wherein said inner layer includes an antimicrobial additive.

13. The antimicrobial product of claim 1, wherein an adhesive layer is placed between said inner layer and said outer layer.

14. The process of making an antimicrobial product comprising coextruding an inner layer and an outer layer containing an antimicrobial additive on top of said inner layer.

15. The process of claim 14, wherein said inner layer includes an antimicrobial additive.

16. The process of claim 14, wherein an adhesive layer co-extruded between the inner layer and the outer layer.

17. An antimicrobial heat-shrinkable tubing comprising a crosslinked inner layer and an outer layer surrounding said inner layer, wherein said outer layer includes an antimicrobial additive.

18. The antimicrobial heat-shrinkable tubing of claim 17, wherein said inner layer comprises a polymer selected from the group consisting of polyolefins, ethylene-vinyl acetate, polyamides, and ethylene methyl acrylate polymers.

19. The antimicrobial heat-shrinkable tubing of claim 17, wherein said inner layer comprises a polymer, a flame retardant and an antioxidant.

20. The antimicrobial heat-shrinkable tubing of claim 17, wherein said inner layer includes an antimicrobial additive.
